(19) United States
(12) Patent Application Publication
(10) Pub. No.: US 2003/0189735 A1
(43) Pub. Date: Oct. 9, 2003

(54) Film scanner

(75) Inventor: Yuichi Kurosawa, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/408,307

(22) Filed: Apr. 8, 2003

(30) Foreign Application Priority Data
Apr. 9, 2002 (JP) 2002-105982

(51) Int. Cl. H04N 1/04; H04N 1/047; H04N 1/10

(52) U.S. Cl. 358/474; 358/487; 358/488

(57) ABSTRACT

A film scanner that scans an image of a developed film by an imaging device includes a film holder, a film side discriminating unit, and an image processor. The film holder is arranged to hold the developed film with one side thereof faced toward the imaging device. The film side discriminating unit determines which side of the film held by the film holder is an emulsion side. The image processor reverses an image captured from the film to produce an erect image when the film side discriminating unit has determined that the side of the film not facing the imaging device is the emulsion side. Accordingly, the film scanner arranged as above can produce an erect image even if the film strip is placed in the film holder with wrong side thereof faced toward the imaging device.

### BACKGROUND OF THE INVENTION

The present invention relates to a film scanner for capturing images formed on a photographing film.

Recently, images formed on a photographing film are often captured by a film scanner to process and/or store image data in personal computers or the like.

Generally, the film scanner is provided with a film holder configured to hold a film strip obtained by cutting a 35 mm film or a brownie film for every predetermined numbers of frames. The film holder is inserted into the film scanner and the film strip held in the film scanner is illuminated by a light source so that the image on the film strip is formed on a CCD line sensor by an imaging lens. The CCD line sensor scans the image on the film strip in one direction, or a principal scanning direction, and by moving the line sensor relative to the image in a direction perpendicular to the principal scanning direction, or an auxiliary scanning direction, the whole image on the film strip can be captured.

In the film scanner mentioned above, it is expected that the film strip be placed in the film holder with the emulsion side, or the front side, thereof faced toward the CCD line sensor so that the film scanner can capture an erect image. However, since the emulsion is applied on a thin and transparent base film, it is quite difficult to discriminate the emulsion side and the base film side of the film strip and the film strip is often inserted into the film holder with the emulsion side located at the wrong side, which causes the film scanner to capture a reversed image.

Therefore, there is a need for a film scanner that is capable of producing an erect image even if the film strip is held reversely in the film holder.

### SUMMARY OF THE INVENTION

The present invention is advantageous in that a film scanner is provided that satisfies the above-mention need.

According to an aspect of the invention there is provided a film scanner that captures an image of a developed film by an imaging device. The film scanner includes a film holder, a film side discriminator, and an image processor. The film holder is arranged to hold the developed film with one side thereof facing toward the imaging device. The film side discriminator determines which side of the film held by the film holder is an emulsion side. The image processor reverses an image captured from the film to produce an erect image when the film side discriminator determines that a side of the film not facing the imaging device is the emulsion side. Accordingly, the film scanner arranged as above can produce an erect image even if the film strip is placed in the film holder with a wrong side thereof facing toward the imaging device.

Optionally, the discriminator includes a light source arranged to emit a light beam toward a side of the film held in the film holder, and a photo detector arranged to receive the light beam reflected at the side of the film.

The film side discriminating unit arranged as above can determine which side of the film is the emulsion side based on the characteristic of the light beam received by the photo detector since the light reflecting characteristic of the emulsion side of the film strip differs from that of the other side.

For example, the emulsion side of the film strip can be determined based on the width of the light beam received by the photo detector, since the light beam reflected at the emulsion side is more diffused and hence becomes wider than the light beam reflected at the other side.

Specifically, the photo detector may include a two dimensional array having a plurality of photosensitive elements, and the film side discriminator may determine whether the light beam is reflected at the emulsion side of the film based on the number of the photosensitive elements that receive the light beam.

Optionally, the film side discriminator includes a first light source arranged to emit a first light beam toward a first side of the film held by the film holder, a first photo detector arranged to receive the first light beam reflected at the first side of the film, a second light source arranged to emit a second light beam toward a second side of the film held by the film holder, and a second photo detector arranged to receive the second light beam reflected at the second side of the film. The film side discriminator arranged as above can determine the emulsion side of the film based on the outputs of the first and second photo detectors.

Further optionally, each of the first and second photo detectors includes a two dimensional array having a plurality of photosensitive elements. In this case, the film side discriminator can determine the emulsion side of the film by comparing the number of the photosensitive elements of the first photo detector that receive the first light beam with the number of the photosensitive elements of the second photo detector that receive the second light beam.

It should be noted that since the film strip is manufactured by applying the emulsion on a thin base film, the film strip bends such that the emulsion side becomes concave. Therefore, according to some embodiments of the invention, the film side discriminator is arranged so as to determine the emulsion side of the film by detecting a concave side of the film.

The concave side of the film can be detected, for example, by determining the distances from the imaging device to a plurality of points defined on said film. In exemplary embodiments of the invention, one of the plurality of points is a center reference point defined substantially at a center of one frame of the film and the other points are side reference points each defined in a vicinity of the edges of the frame.

In some embodiments of the invention, the film side discriminator may includes, an imaging lens located between the imaging device and the film holder and forming an image of the film on the imaging device, and a lens driver that moves the lens along an optical axis thereof to adjust the focus of the imaging lens on the film. The film side discriminator determines positions of a plurality points defined on the film in a direction parallel to the optical axis by adjusting focus of the imaging lens on each of the points, and detects the concave side of the film based on the positions of those points. In exemplary embodiments of the invention, one of the plurality of points is a center reference point defined substantially at a center of one frame of the film and the other points are side reference points each defined in a vicinity of the edges of the frame.

### BRIEF DESCRIPTION OF THE ACCOMPANYING DRAWINGS

FIG. 1 schematically shows a perspective view of a part of a film scanner according to a first embodiment of the invention;

FIG. 2 is a front view of the film scanner shown in FIG. 1;

FIGS. 3A and 3B schematically show perspective views of a film holder according to the first embodiment of the invention;

FIG. 4 is a cross section of the film holder taken along the line IV-IV in FIG. 3B;

FIG. 5 is a perspective view of the APS film adapter according to the first embodiment of the invention;

FIG. 6 shows a control system of the film scanner according to the first embodiment;

FIG. 7 is a flowchart illustrating a sub-routine scanning procedure of the film scanner according to the first embodiment of the invention;

FIG. 8 shows a flowchart illustrating a sub-routine FILM STRIP SCANNING PROCEDURE according to the first embodiment of the invention;

FIG. 9 shows a flowchart illustrating a sub-routine FILM SIDE CHECKING PROCEDURE according to the first embodiment of the invention;

FIG. 10 shows a flowchart illustrating a sub-routine APS FILM SCANNING PROCEDURE according to the first embodiment of the invention;

FIG. 11 shows a flowchart illustrating the sub-routine ENDING PROCEDURE according to the first embodiment of the invention;

FIG. 12A schematically shows a plane view of one frame on a film strip that is to be scanned by the film scanner according to the second embodiment;

FIGS. 12B and 12C schematically show cross sectional views of the frame shown in FIG. 12A along line XIIA-XIIA and line XIIB-XIIB, respectively;

FIG. 13 schematically shows a perspective view of a part of the film scanner according a second embodiment of the invention;

FIG. 14 schematically shows a front view of the film scanner shown in FIG. 13;

FIG. 15 shows a control system of the film scanner according to the second embodiment of the invention; and

FIG. 16 shows a flowchart of the sub-routine FILM SIDE CHECKING PROCEDURE according to the second embodiment of the invention.

### DETAILED DESCRIPTION OF THE EMBODIMENTS

Hereinafter, embodiments of the present invention will be described with reference to the accompanying drawings.

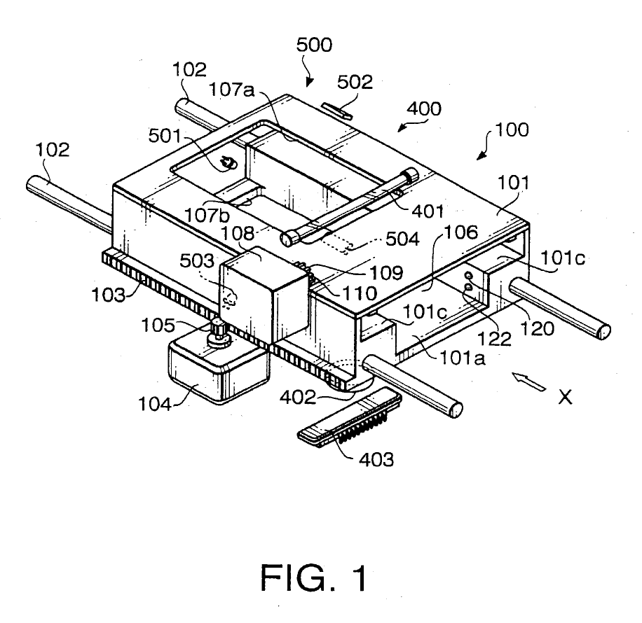

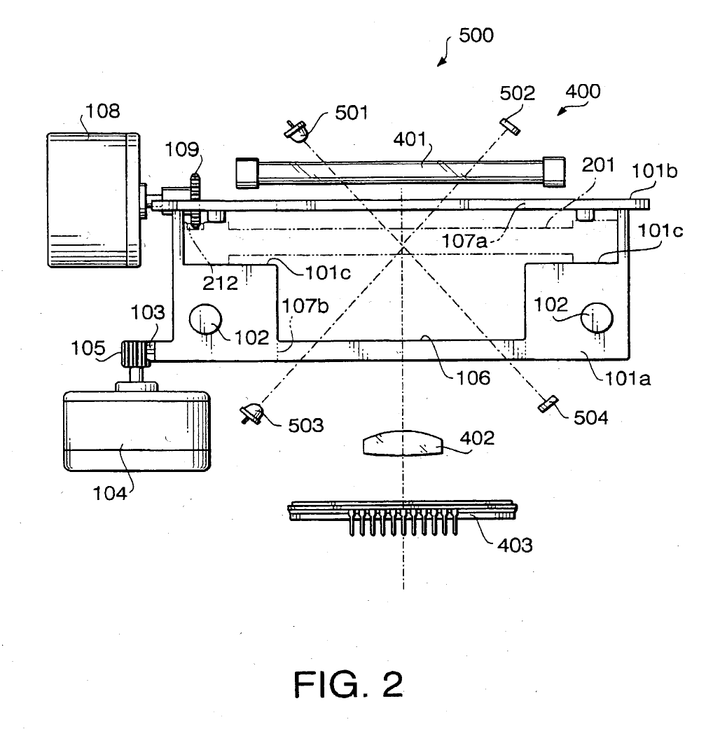

FIG. 1 schematically shows a perspective view of a part of a film scanner 100 according a first embodiment of the invention. FIG. 2 is a front view of the film scanner 100 shown in FIG. 1 observed from a direction indicated by an arrow X.

The film scanner 100 is provided with a pair of guide rods 102 that is supported within a housing (not shown) of the film scanner 100. The guide rods 102 are arranged so as to extend horizontally when the film scanner 100 is placed for use.

A table 101 is slidably mounted to the guide rods 102. A rack 103 is integrally formed on one of the side surfaces of the table 101 near the bottom edge thereof so as to extend in parallel to the guide rods 102.

A main-scanning motor 104 is fixed to the housing (not shown) of the film scanner 100 at a location adjacent to the rack 103. A spindle shaft of the main-scanning motor 104 is provided with a pinion 105 that is engaged with the rack 103 of the table 101. The main-scanning motor 104 drives the table 101 back and forth in a direction parallel to the guide rods 102 (i.e., in a auxiliary scanning direction).

The table 101 includes a base 101a and a top plate 101b fixed on the base. The base 101a has a pair of stepped side walls 101c and a holder supporting groove 106 formed between the side walls 101c so as to extend in parallel to the guide rods 102. The holder supporting groove 106 is formed such that a film holder 201 and an APS (advanced photo system) film adapter 301, which will be described later, can be inserted and thereby held therein.

First and second holder sensors 120 and 122 are provided to the inner surface of one of the side walls 101c. The first holder sensors 120 detects whether a holder (the film holder 201 or the APS film adapter 301) is currently inserted into the holder supporting groove 106. The second holder sensor 122 detects a mark provided on the holder to indicate the type of the holder (i.e., the film holder 201 or the APS film adapter 301).

A rectangular upper scanning window 107a is formed to the top plate 101b, while a rectangular lower scanning window 107b is formed to the base at the bottom of the holder supporting groove 106. The upper and lower scanning windows 107a and 107b are formed in substantially the same shape and size, and the lower scanning window 107b is located substantially below the upper scanning window 107a.

A pre-scanning motor 108 is mounted on one of the side surfaces of the table 101, preferably, on the side surface on which the rack 103 is formed. The spindle shaft of the pre-scanning motor 108 is provided with a pinion 109 that is to be engaged with a rack formed on the film holder 201 or the APS film adapter 301, which will be describe later, through an opening 110 formed to the top plate 101b of the table 101.

It should be noted that both the main-scanning motor 104 and the pre-scanning motor 108 are pulse motors that are driven by pulse signals and revolve for a predetermined angle in response to one pulse of the pulse signal.

A part of the area within which the table travels along the guide rods 102 is defined as an image reading section 400. A diffusive light source 401, an imaging lens 402, and a CCD line sensor 403 are provided within the image reading section 400. As shown in FIG. 1, the diffusive light source 401 and the imaging lens 402 are arranged such that the table 101 passes therebetween as it travels along the guide rods 102 to allow the light emitted from the light source 401 passing through the upper and lower scanning windows (107a, 107b). The diffusive light source 401 emits diffused light toward the imaging lens 402, and the imaging lens 402 converges the light from the diffusing light source 403 to form an optical image on the CCD line sensor 403 located below the imaging lens 402. The CCD line sensor 403 includes a plurality of CCD elements that generates electrical signals in accordance with the optical image formed thereon. The plurality of CCD elements is arranged linearly and at a constant pitch in a direction perpendicular to the direction in which the table 101 moves and parallel to a plane along which the table 101 moves.

It should be noted that although only one line sensor 403 is shown in FIG. 1, three line sensors may be provided below the imaging lens 402, which are sensitive to different colors such as red, green, and blue, to allow the film scanner 100 scanning a color image.

As shown in FIG. 2, the film scanner 100 is further provided with a film front face detecting unit 500 that includes first and second light emitting devices, or LEDs 501 and 503, and first and second light detecting devices, or photo diode arrays 502 and 504. Each of the first and second photo diode arrays 502 and 504 includes a plurality of photo diodes that are two dimensionally arranged.

The first LED 501 and the first photo diode array 502 are located above the path along which the table 101 travels. The first LED 501 and the first photo diode array 502 are arranged such that, when the table 101 is located therebelow, the light emitted from the first LED 501 passes through the upper scanning window 107a, reflected at the upper surface of a film held within the table, and then received by the first photo diode array 502.

The second LED 503 and the second photo diode array 504 are located below the traveling path of the table 101, and arranged such that the light emitted from the second LED 503 impinges on the under surface of the film within the table 101 and reflected toward the second photo diode array 504 when the table 101 is located above the second LED 503 and the second photo diode array 504.

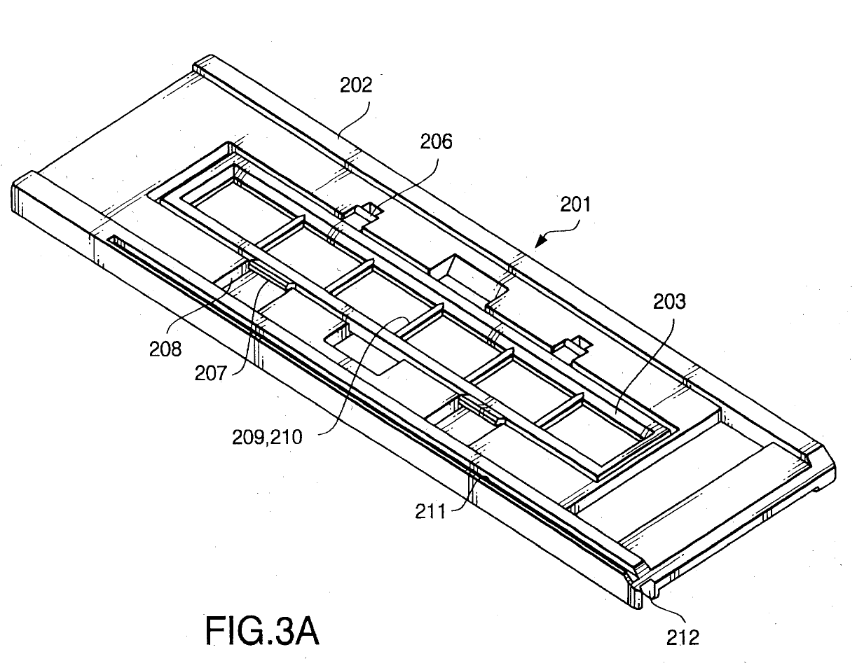

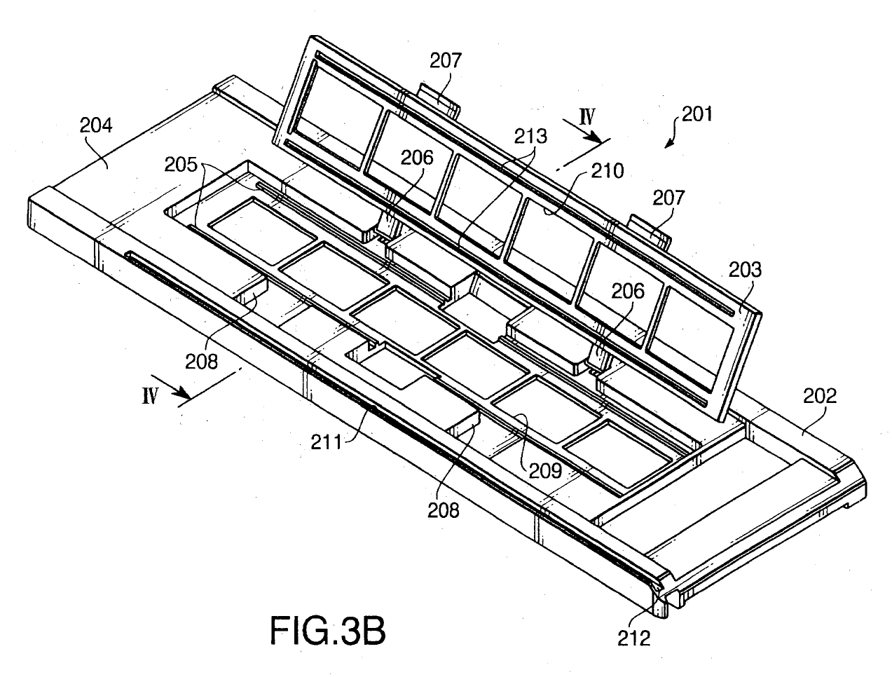

FIGS. 3A and 3B schematically show perspective views of a film holder 201 according to the first embodiment of the invention that is to be inserted into the film scanner 100 shown in FIG. 1. FIG. 4 shows a cross section of the film holder taken along the line IV-IV in FIG. 3B together with the film front face detecting unit 500.

The film holder 201 shown in FIGS. 3A and 3B is configured to hold a film strip made by cutting a 35 mm film so as to include six photograph frames. It should be noted that,the film holder 201 may be also configured so as to hold brownie films or slide films therein.

The film holder 201 includes a base 202 and a film presser 203 that is connected to the base 202 by two hinges 206 so as to be movable between an open position, as shown in FIG. 3B, and a closed position as shown in FIG. 3A.

The film holder 201 is provided with a groove 211 extending in a longitudinal direction thereof. The groove 211 is formed in the vicinity of one side edge of the film holder 201. As shown in FIG. 4, a rack 212 is formed within the groove, which is to be engaged with the pinion 109 mounted to the pre-scanning motor 108.

As shown in FIG. 3B the film holder 201 is further provided with a shallow rectangular film receiving recess 204 for receiving the film strip. The film presser 203 is formed in a shape and size that can be placed within the film receiving recess 204 when moved to the closed position shown in FIG. 3A. The film presser 203 is provided with two protrusions 207 that engage with respective grooves 208 formed to the base 202 when the film presser 203 is moved to the closed position and thereby keep the film holder 201 be closed.

Each of the base 202 and the film presser 203 is provided with six rectangular frame windows (209, 210) arranged along the longitudinal direction of the film holder 201. Each frame window (209, 210) is formed as a through hole extending in the thickness direction of the film holder 201. The size of each frame window 203 corresponds to the size of the photographing frame formed on the film strip.

A pair of guide rails 205 is formed on the bottom of the film receiving recess 204. The guide rails 205 are formed near respective sides of the frame windows 209 and extend along the longitudinal direction of the film holder 200. The film strip is placed between the pair of guide rails 205 in order to prevent displacing in the width direction thereof within the film receiving recess 204.

The film presser 203 is provided with two elongated grooves 213 formed at the under surface of the film presser 203 to extend in the longitudinal direction of the film holder 201 near respective sides of the frame windows 210. When the film holder 201 is closed, the guide rails 205 of the base fits into respective grooves 213 of the film presser 203 and the film strip placed between the guide rails 205 is sandwiched between the bottom of the film receiving recess 204 and the under surface of the film presser 203.

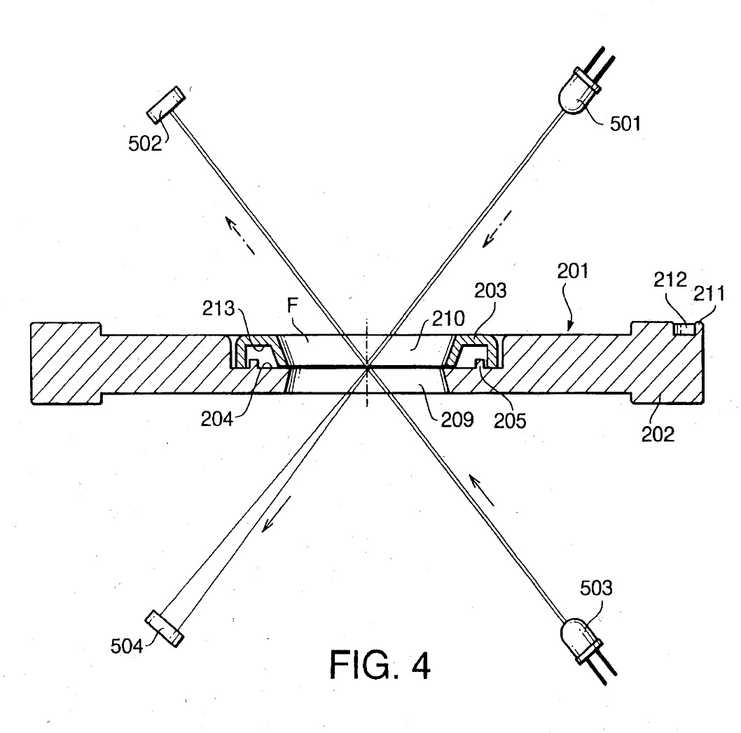

FIG. 5 is a perspective view of the APS film adapter 301 according to the first embodiment of the invention that is to be inserted to the film scanner 100 shown in FIG. 1. The APS film adapter 301 has a substantially parallelepiped form that can be inserted into the holder supporting groove 106 of the film scanner 100. A pair of flange portions 302 is provided to the APS film adapter 301 at both sides thereof. The flange portions 302 slide on the stepped portions of the side walls 101c of the table 101 when the APS film adapter 301 is inserted into the table 101.

An elongated groove 303 is formed to the upper surface of one of the flange portions 302. The groove 303 is located near the side edge of the flange portion 302 and extends in a longitudinal direction of the APS film adapter 301. A rack 304 is formed within the groove 303, which is to be engaged with the pinion 109 provided to the pre-scanning motor 108.

An opening, or frame window 305, is formed at substantially the center area of the APS film adapter 301, which penetrates the APS film adapter 301 from the top surface to the under surface thereof.

The APS film adapter 301 accommodates an APS film cartridge (not shown) and wind/rewind the film of the APS film cartridge with a built-in motor (not shown) to align arbitrary photograph frame to the frame window 305.

A plurality of contact electrodes 306 is provided, in a line, on the upper surface of the APS film adapter 301 in the vicinity of the rear end thereof. The contact electrodes 306 are biased to elastically contact with respective electrodes (not shown) provided to the table 101 as the APS film adapter 301 is inserted into the holder supporting groove 106. Control signals and power for winding/rewinding the film of the APS film cartridge are provided to the APS film adapter 301 through the contact electrodes 306 for driving the built-in motors (not shown).

It should be noted that the APS film cartridge can be inserted into the APS film adapter 301 only in a predetermine manner and hence APS film cannot be set to the APS film adapter 301, with the front and rear faces reversed.

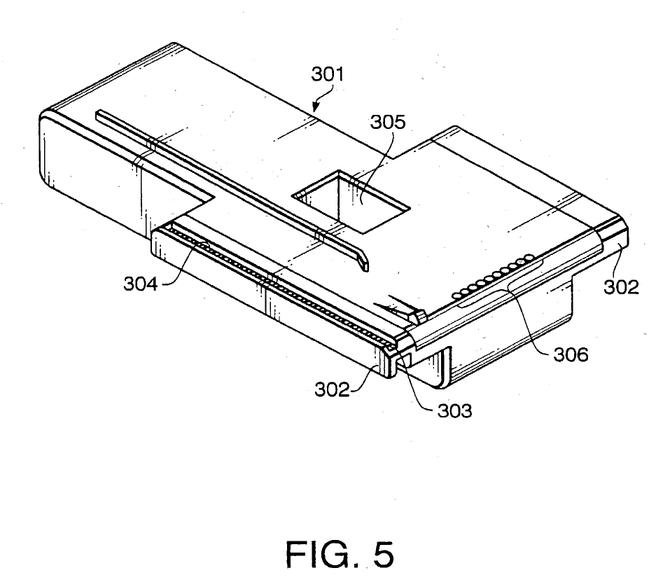

FIG. 6 shows a control system of the film scanner 100 shown in FIG. 1.

The CCD line sensor 403 is driven by a line sensor driving circuit (CCD driver) 141, which is controlled by a system controller 140. The output signal generated by the CCD line sensor 403 in accordance with the image formed thereon by the imaging lens 402 is amplified by an amplifier 142: and then converted into a digital signal by an A/D converter 143. Then, a predetermined image processing is applied by an image processing circuit 144 to generate an image signal having a predetermined format.

A memory 145 is provided for storing the processed image signal as an image data. For example, an IC card may be used as the memory 145. The image signal is applied to an output terminal 147 via an interface circuit 146. The output signal is transmitted from the I/O terminal 147 to, for example, a (not shown) personal computer.

The diffusive light source 401 is driven by a light source driving circuit 148, which is controlled by the system controller 140.

The main-scanning motor 104 and the pre-scanning motor 108 are also controlled by the system controller 140 to rotate and thereby move the table 101 or the film holder 201 held in the table 101.

The first and second LEDs 501 and 503 of the film front face detecting unit 500 is connected to the system controller 140 via a LED driving circuit 149 and turn on and off in accordance with the control of the system controller 140. The first and second photo diode arrays 502 and 504 are also connected to the system controller 140 so that the system controller 140 can determine which photo diode of the photo diodes array (502, 504) is receiving light.

The system controller 140 is further connected with the first and second holder sensor 120 and 122 to determine whether the film holder 201 or the APS film adapter 301 is set to the film scanner 100.

The system controller 140 is also connected with an operation panel 152 via an interface 151. A control signal representing start/end of scanning operation and/or designating a frame to be scanned is input through the operation panel 152. The system controller 140 stores the instruction input through the operation panel 152 in a RAM 140M provided therein.

Further, the system controller 140 detects the position of the table 101 and the film holder 201 based on the number of pulses applied to each of the main-scanning motor 104 and the pre-scanning motor 108 and store the same in the RAM 140M.

Next, the operation of the film scanner 100 according to the first embodiment will be described.

Initially, the film strip to be scanned is set to the film holder 201. That is, the protrusions 207 of the film presser 203 are disengaged from the grooves 208 of the base 202 to move the film presser 203 to the open position shown in FIG. 3B. Then, the film strip is placed between the guide rails 205 in the film receiving recess 204 with the emulsion side thereof faced against the bottom of the film receiving recess 204. At this state, the displacement of the film strip in the width direction thereof is restricted by the pair of guide rails 205 while the displacement in the longitudinal direction of the film strip is prevented by the front and rear end of the film receiving groove 204.

Then, the film presser 203 is moved to the closed position to be overlaid on the film strip. The protrusions 207 are engaged with the grooves 208 to fix the film presser 203 at the closed position. As a result, the film strip is sandwiched between the base 202 and the film presser 203 as shown in FIG. 4, with the front and rear faces thereof being in contact with the base 202 and the film presser 203, respectively, and each photograph frame exposing through the respective frame windows (209, 210).

The film holder 201 is then inserted into the holder supporting groove 106 of the table 101. Alternatively, the APS film adapter 301 shown in FIG. 5 may be inserted into the table 101. Then, the scanning procedure of the film scanner 100 is carried out.

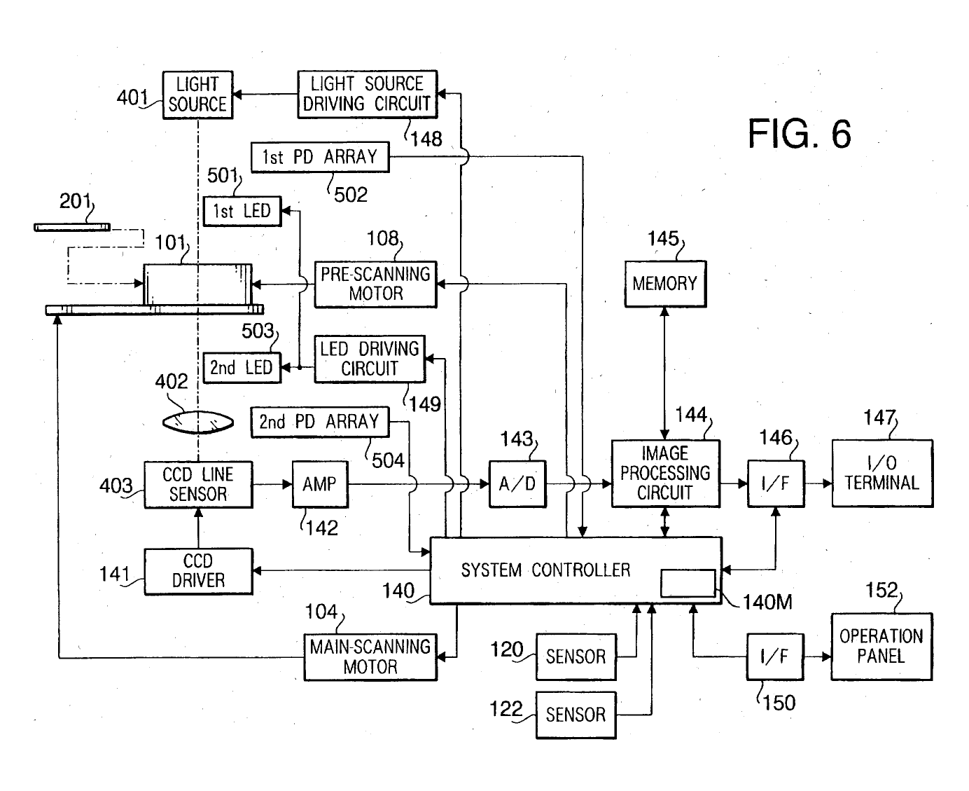

FIG. 7 is a flowchart illustrating a scanning procedure of the film scanner 100 according to the first embodiment.

After the main switch of the film scanner 100 is turned on, the system controller 140 waits for insertion of a holder (i.e., the film holder 201 or the APS film holder 301) (S102). If no holder is inserted within a predetermined time (S102:NO, S104:YES), then the film scanning procedure is terminated.

If the system controller 140 receives a signal from the first sensor 120 that indicates insertion of a holder into the table 101 (S102:YES), then the system controller 140 drives the main-scanning motor 104 to move the table to an initial position (S106). The initial position is a position at which the table 101 has not yet reached the scanning position and is apart therefrom by a predetermined distance.

Then the light source 401 is turned on to emit diffused light (S108). Since the table 101 has not yet reached the scanning position, the light is directly incident on the imaging lens 402, and is received by the line sensor 403. Based on the detection results of the line sensor 403, the image processing circuit 144 generates data for shading compensation (S110).

In step S116, the system controller 140 waits for receipt of a signal from the operation panel 152 instructing operation of the film scanner 100, i.e., pre-scanning or main-scanning and a frame number, or end of operation. The system controller 140 waits for the signal for a predetermined period of time (S116:NO, S118:NO).

If the system controller 140 does not receives the signal within the predetermined period of time (S118:YES), then control goes to step S120 where a sub-routine ENDING PROCEDURE is called. If the system controller 140 receives the signal from the operation panel 152 (S116:YES), and if the received signal represents the end of scanning operation (S122:YES), then control goes to step S120, too.

If the received signal represents the pre-scanning or the main-scanning (S122:NO), then the main-scanning motor 104 is driven to locate the table 101 at a scanning start position (S124). The scanning start position is a position at which an end portion (front end portion) of the scanning window 107a is located at the scanning position.

Next, the system controller 140 judges whether the holder currently inserted into the film scanner 100 is the film holder 201 or the APS holder 301 based on the signal generated by the second holder sensor 122 of the table 101 (S126). If the film holder 201 is currently inserted (S126:YES), then the control goes to step S128 where a sub-routine FILM STRIP SCANNING PROCEDURE is called (S128), while a sub-routine APS FILM SCANNING PROCEDURE is called if the currently inserted holder is the APS film holder 301 (S126:NO, S130).

After step S128 or 5130 is carried out, the control returns to step S116.

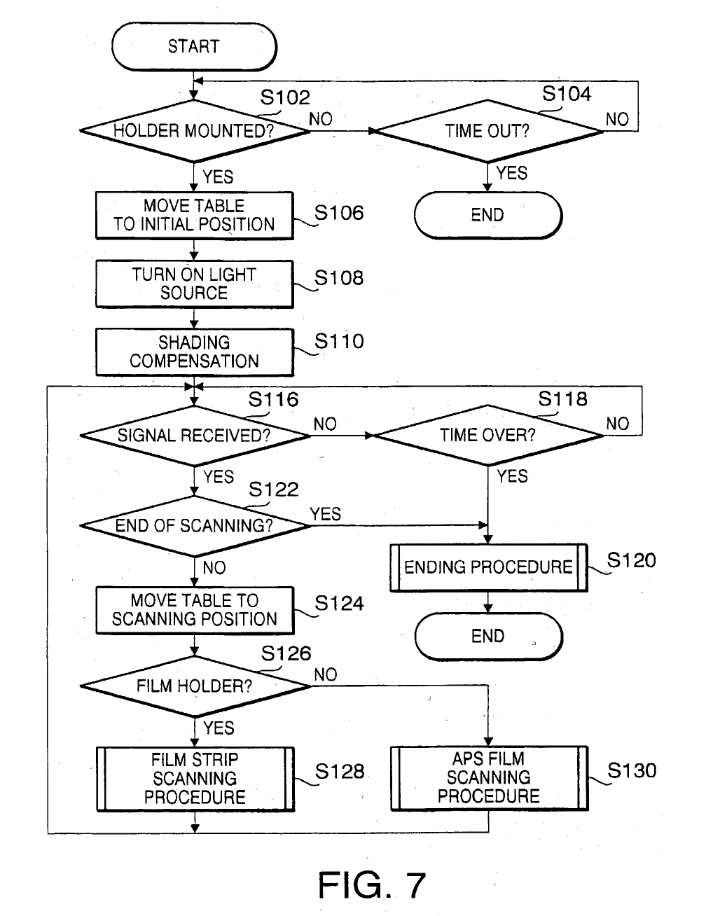

FIG. 8 shows a flowchart illustrating the FILM STRIP SCANNING PROCEDURE according to the first embodiment of the invention.

In step S152, the film holder 201 is moved by driving the pre-scanning motor 108 to align the frame window (209, 210) corresponding to the designated frame with the scanning window (107a, 107b).

In step S154, it is judged whether the sub-routine FILM SIDE CHECKING PROCEDURE has been executed for the designated frame. If it is not yet executed for the currently designated frame, then the sub-routine FILM SIDE CHECKING PROCEDURE is called (S154:NO, S156). In the FILM SIDE CHECKING PROCEDURE, it is determined whether the film strip to be scanned is held in the film holder 201 with the emulsion side thereof faced toward the CCD line sensor 403, and whether the scanned image should be electronically reversed or not.

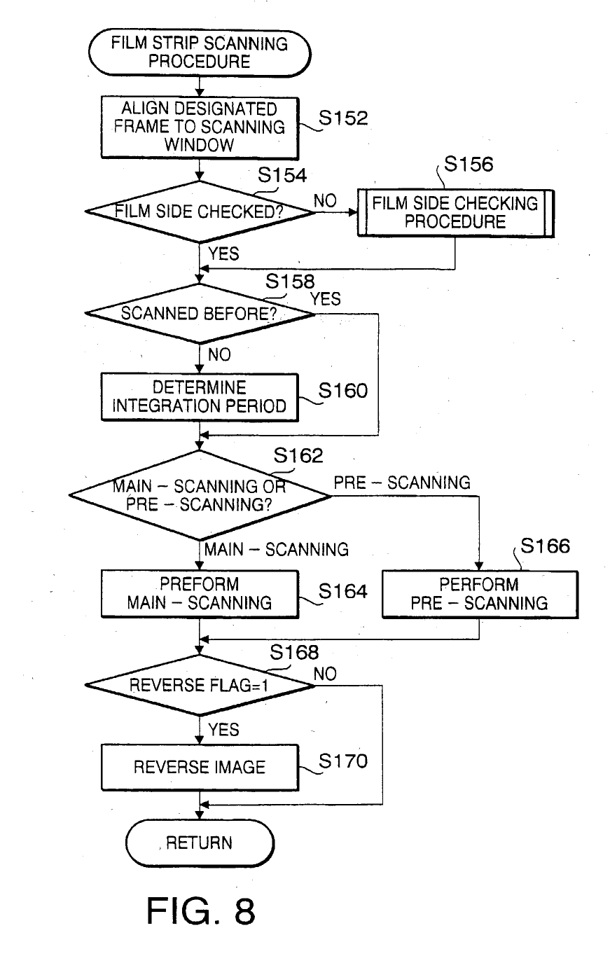

FIG. 9 shows a flowchart illustrating the FILM SIDE CHECKING PROCEDURE according to the first embodiment of the invention.

In step S202, the first LED 501 of the film front face detecting unit 500 is turned on to irradiate light on the upper surface of the film strip held within the film holder 201.

The light reflected by the upper surface of the film strip is received by the first photo diode array 502. The system controller 140 determines the number of photo diodes of the first photo diode array 502 that has detected the reflected light and stores it into a variable n1 (S204).

Next, the second LED 503 is turned on (S206). The light emitted from the second LED 503 impinges on the under surface of the film strip and reflected toward the second photo diode array 504. The system controller 140 determines the number of photo diodes of the second photo diode array 504 that has detected the reflected light and stores it into a variable n2 (S208).

Next, the system controller 140 judges which side of the film is the emulsion side by comparing the values of n1 and n2. (S210). Since the base of the film is a resin having a relatively flat surface, the light emitted by the LED (501, 503) impinging on the side of the film opposite to the emulsion side will be reflected without being significantly diffused. Thus, the beam spot formed on the photo diode array (502, 504) becomes relatively small, resulting in small number of photo diodes detecting the reflected light.

On the contrary, if the light emitted by the LED (501, 503) is reflected at the emulsion side of the film strip, the light will be diffused and form a relatively large beam spot on the photo diode array (502, 504), which increases the number of photo diodes that detect the reflected light. Accordingly, it can be determined which side of the film strip is the emulsion side thereof by comparing the values of the variables n1 and n1.

If the value of n1 is larger than n2 (S210:YES), the film strip held in the film holder 201 has the emulsion side thereof faced toward the light source 401. In other words, the film strip is reversely held in the film holder 201. Accordingly, the CCD line sensor 403 will obtain an upside down image by scanning the film strip. In this case, the system controller 140 set a REVERSE FLAG (S212), which indicates that the image captured by scanning the film strip should be reversed to obtain an erect image.

If the value of n1 is not larger than n2 (S210:NO), the film strip is held within the film holder 201 with the emulsion side faced toward the CCD line sensor 403 and the film scanner 100 can capture an erect image by scanning the film strip. Therefore, the REVERSE FLAG is cleared in this case so that a process for reversing the captured image will not be carried out later (S214).

After step S212 or S214 is executed, the control returns to the sub-routine FILM STRIP SCANNING PROCEDURE shown in FIG. 8.

Referring back to FIG. 8, the control goes to step S158 if it is judged in step S154 that the sub-routine FILM SIDE CHECKING PROCEDURE has been executed for the currently designated frame.

In step S158, it is judged whether scanning of the currently designated frame has been done before. If pre-scanning or main-scanning of the currently designated frame has not yet been carried out (S158:NO), an integration period of the CCD line sensor 403 is determined and stored in the RAM 140M (S160).

Next, it is judged whether a main-scanning or a pre-scanning of the designated frame is to be done (S162) and either the main-scanning or the pre-scanning is performed in accordance with the judgment at S162 (S164, S166).

If the main-scanning is to be done, the main-scanning motor 104 is driven to move the table 101 along the guide rods 102. As a result, the film strip in the table moves relative to the CCD line sensor in the auxiliary direction and allows the CCD line sensor 403 to scan the whole area of the designated frame (S164).

If the pre-scanning is to be done, the pre-scanning motor 108 is driven to slide the film holder 201 along the holder supporting groove 106 of the table 101 and thereby allows the CCD line sensor 403 to scan over the designated frame (S166).

It should be noted that the step angle of the pre-scanning motor 108 is larger than that of the main-scanning motor 104 and hence the scanning pitch in the auxiliary direction is larger in the pre-scanning than in the main-scanning. Accordingly, the time required for the pre-scanning of one frame is shorter than that required for the main-scanning. The pre-scanning may be used for confirming the content of the frame and/or checking the contrast and/or the scanning area of the image before performing the main-scanning.

In step S168, it is determined whether the REVERSE FLAG is on, and only in the case the REVERSE FLAG is on, the image captured in step S164 or S166 is reversed by transforming the coordinates of the pixels of the image with one of the following equations (S170):

(X,Y)=(x, −y) (1)

(X,Y)=(−x, y) (2)

where (x, y) represent the coordinate of the pixel of the original image and (X, Y) the coordinate of the pixel of the processed image.

Since the captured image is reversed as above when the REVERSE FLAG is on, the film scanner 100 according to the embodiment of the invention can provide an erect image even if a user could not distinguish the front face or the emulsion side of the film strip and has placed the film strip into the film holder 201 with the front and rear face reversed.

After step S170 is executed, or if it is found that the REVERSE FLAG is not on in step S168 (S168:NO), the control returns to the main procedure shown in FIG. 7.

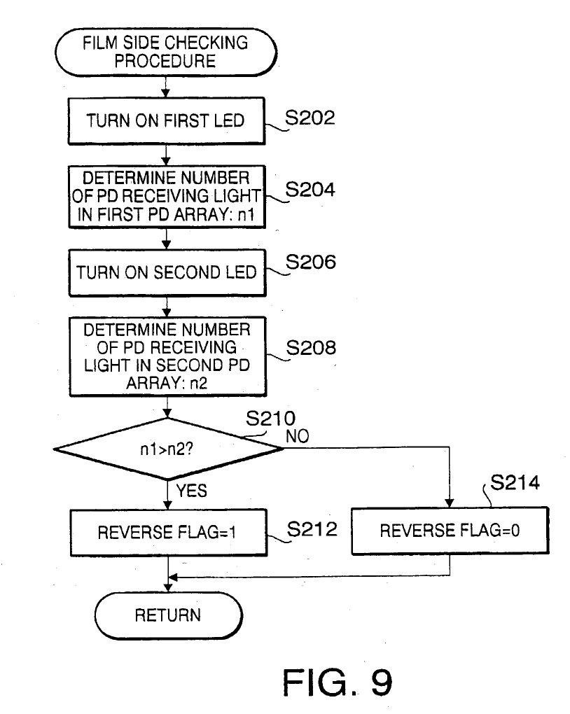

FIG. 10 shows a flowchart illustrating the sub-routine APS FILM SCANNING PROCEDURE according to the first embodiment of the invention. As described before, this sub-routine is executed when the APS film adapter 301 is inserted into the table 101.

In step S252, it is judged whether the step is executed first time. If step S252 is executed first time (S252:YES), the system controller 140 drives the pre-scanning motor 104 to align the frame window 305 of the APS film adapter 310 with the scanning window (107a, 107b) of the table 101 (S254).

Next, the (not shown) built-in motor of the APS film adapter 301 is driven to align the designated frame of the APS film with the frame window 305 and hence with the scanning window (107a, 107b) (S256).

Then, a series of steps S258-S266 are executed to scan the image on the APS film by either the main-scanning or the pre-scanning, which steps are essentially the same as the steps S158-S166 of FIG. 8. Thus, detailed description of the steps S258 through S266 is omitted.

After steps S258 through S266 is executed, the control returns to the main procedure shown in FIG. 7.

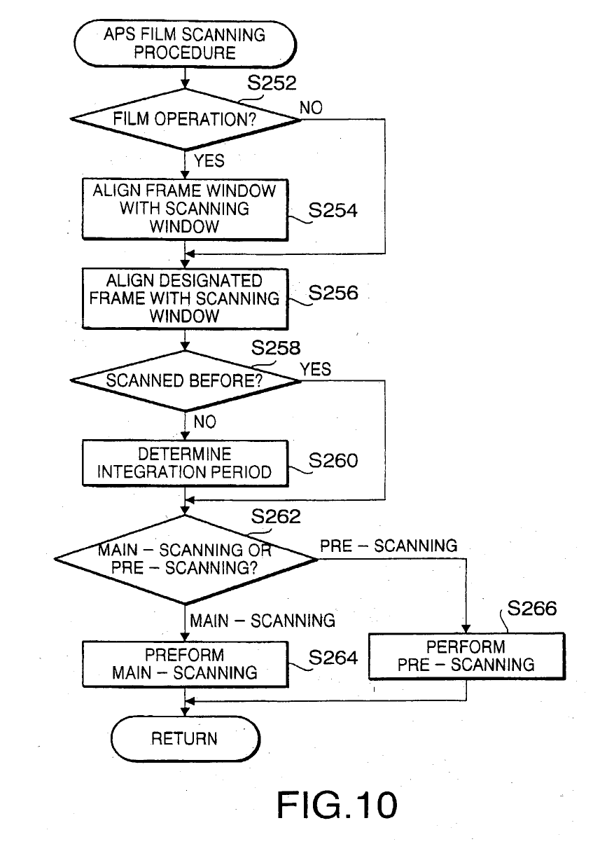

FIG. 11 shows a flowchart illustrating the sub-routine ENDING PROCEDURE according to the first embodiment of the invention. In this procedure, the light source 401 is turned off (S302) and then it is judged whether the film holder 201 is currently held in the table 101 (S304).

If the film holder 201 is in the table 101 (S304:YES), then the film holder 201 is moved back to the most rear position within the table 101 by driving the pre-scanning motor 108 (S306). If the APS film adapter 301 is in the table 101 (S304:NO), control signal and power is provided to the APS film adapter 301 through the contact electrodes 306 thereof to drive the (not shown) built-in motor and thereby rewind the film of the (not shown) APS film cartridge (S308).

After the film holder 201 has been moved back (S306) or the APS film has been rewound (S308), the table 101 is moved back to the most rear position along the guiding rods 102 by driving the main-scanning motor 104 (S310), so that the film holder 201 or the APS film adapter can be removed, and then the control returns to the main procedure shown in FIG. 7.

Hereinafter, a film scanner according to a second embodiment of the invention, which is a variation of the film scanner 100 according to the first embodiment, will be described. Note that in the following embodiment, elements that are substantially the same as those described in the first embodiment are denoted by the same reference numbers to omit detail descriptions thereof.

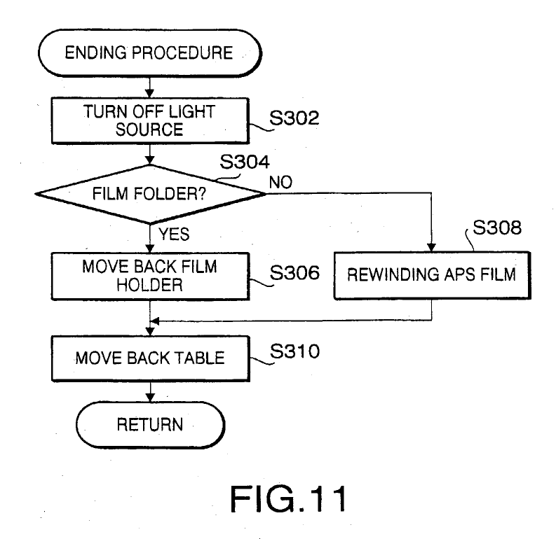

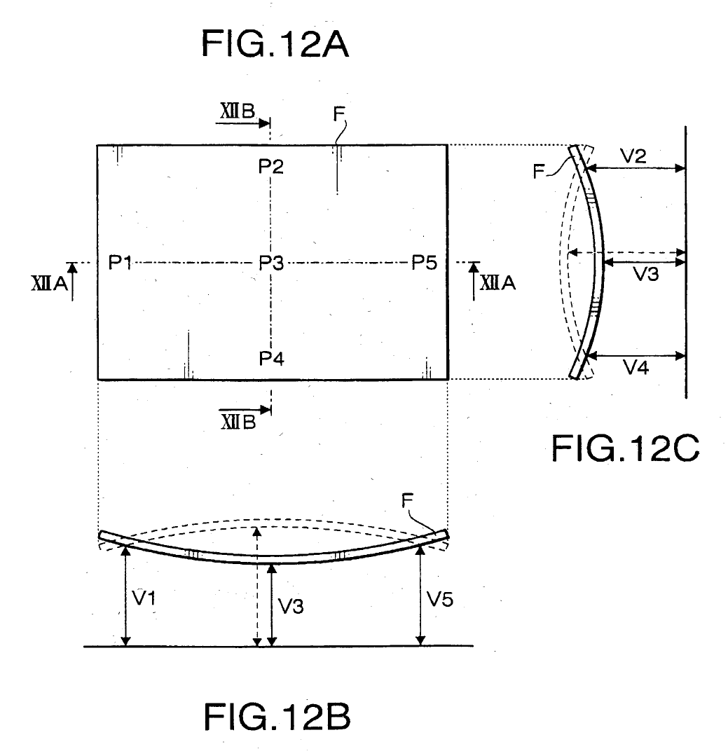

FIG. 12A schematically shows a plane view of one frame F on the film strip that is to be scanned by the film scanner according to the second embodiment, and FIGS. 12B and 12C schematically show cross sectional view of the frame F along line XIIA-XIIA and line XIIB-XIIB of FIG. 12A, respectively.

Generally, the film strip bends such that the emulsion side thereof becomes concave. Therefore, if the upper surface of the film strip is concave as shown in solid lines in FIGS. 12B, the upper surface is the emulsion side of the film strip. On the contrary, if the upper surface is convex as shown in broken lines in FIG. 12B, then the emulsion side is the under surface of the film strip.

A film scanner according to the second embodiment of the invention determines which side of the film strip is concave, or which side of the film strip is the emulsion side, by measuring the distances from the CCD line sensor 403 to several points defined on the frame F. In the present embodiment, five points P1 through P5 are defined on the frame F as shown in FIG. 12A. The point P3 is defined at substantially the center of the frame. The other points P1, P2, P4 and P5 are defined in the vicinity of the midpoint of each edges of the frame F. (Hereinafter, the points P1 and P5 are referred to as front and rear reference points, respectively, the points P2 and P4 as right and left reference points, respectively, and the point P3 as center reference point.)

As may be understood from FIGS. 12B and 12C, the distance to the center reference points P3 will be shorter than the distance to the other points if the upper surface of the film strip is concave, while it will be longer if the upper surface of the film strip is convex. Thus, the film scanner according to the second invention determines the convex side, or the emulsion side, of the film strip by comparing the distance to the center reference points P3 with the distances to the other reference points.

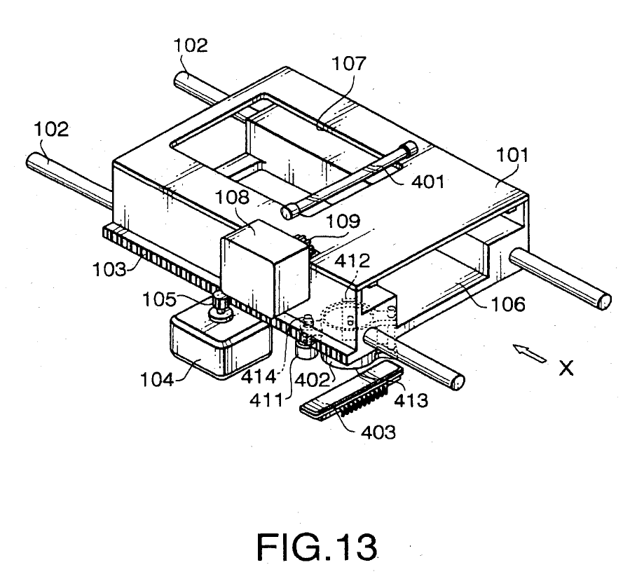

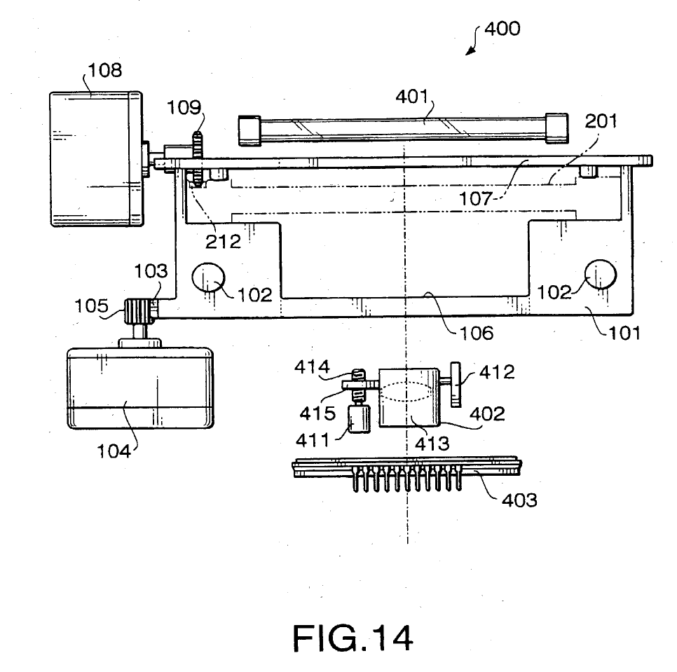

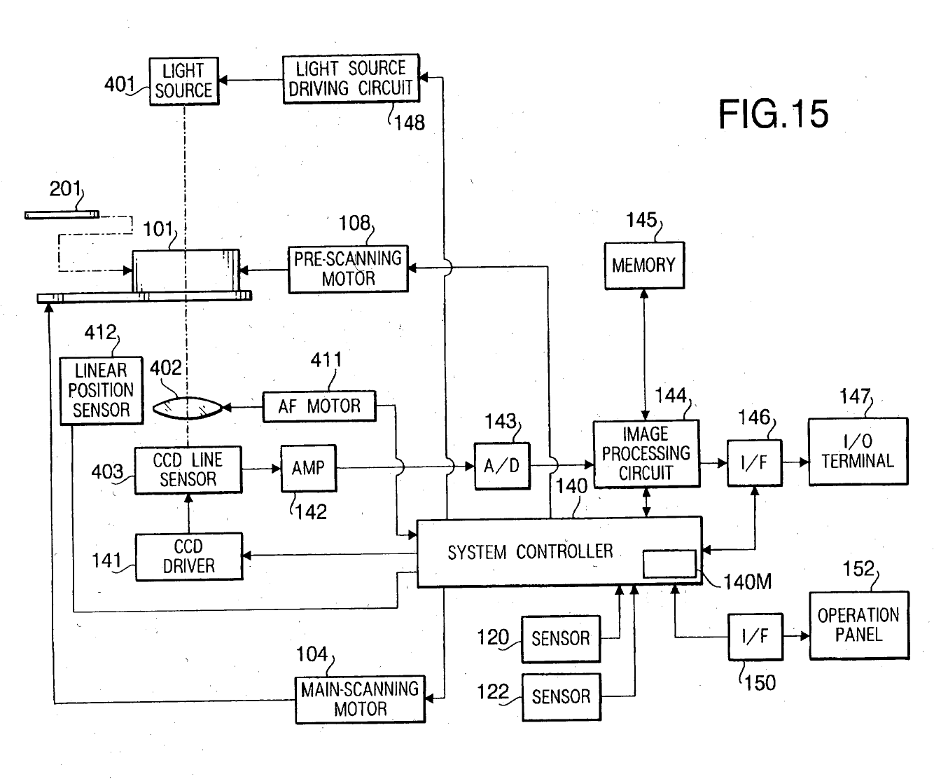

FIG. 13 schematically show a perspective view of a part of the film scanner 600 according the second embodiment of the invention, and FIG. 14 schematically show a front view of the film scanner shown in FIG. 13 observed from the direction indicated by an arrow X. Further, FIG. 15 shows a control system of the film scanner 600 shown in FIG. 13.

The film scanner 600 according to the second embodiment of the invention has substantially the same configuration as the film scanner 100 shown in FIG. 1 except that it is not provided with the film front face detecting unit 500 but with a mechanism for moving the imaging lens 402 along the optical axis thereof to automatically adjust the focus on the film strip to be scanned.

The mechanism for moving the imaging lens 402 includes a lens barrel 413, an AF motor 411, and a linear position sensor 412. The imaging lens 402 is mounted to a (not shown) lens frame that is slidably provided into the lens barrel 413. An extended portion 415 of the (not shown) lens frame protrudes out from the lens barrels 413 and is coupled with a screw 414 attached to the spindle shaft of the AF motor 411. As the AF motor 411 rotates, the (not shown) lens frame is driven by the screw 414 to slide within the lens barrel 413 and thereby move the imaging lens 402 along the optical axis thereof.

The linear position sensor 412 is arranged so as to detect the position of the imaging lens 402 along the optical axis thereof and generate an output signal corresponding to the position of the imaging lens 402 or the position of the film strip in the direction of the optical axis of the imaging lens 402. In the present embodiment, the voltage value of the output signal of the linear position sensor 412 increases as the distance from the CCD line sensor 403 to the point on which the focus is adjusted increases.

As shown in FIG. 15, the AF motor 411 is connected with the system controller 140. The system controller 140 controls the rotation of the AF motor 411, and hence the position of the imaging lens 402 along the optical axis thereof. The system controller 140 controls the position of the imaging lens 402 based on the output signal of the CCD line sensor 403 so that the focus is adjusted for the film strip. For example, the system controller 140 controls the position of the imaging lens 402 such that the contrast of the image captured by the CCD line sensor 403 is optimized.

The linear position sensor 412 is also connected with the system controller 140. Thus, the system controller 140 receives the output signal of the linear position sensor 412, of which voltage indicates the position of the imaging lens 402 and hence the distance from the CCD line sensor 403 to the point where the focus of the imaging lens 402 is adjusted.

The operation of the film scanner 600 according to the second embodiment is essentially the same as that of the film scanner 100 according to the first embodiment except the sub-routine FILM SIDE CHECKING PROCEDURE. Accordingly, only the sub-routine FILM SIDE CHECKING PROCEDURE according to the second embodiment of the invention will be described hereinafter.

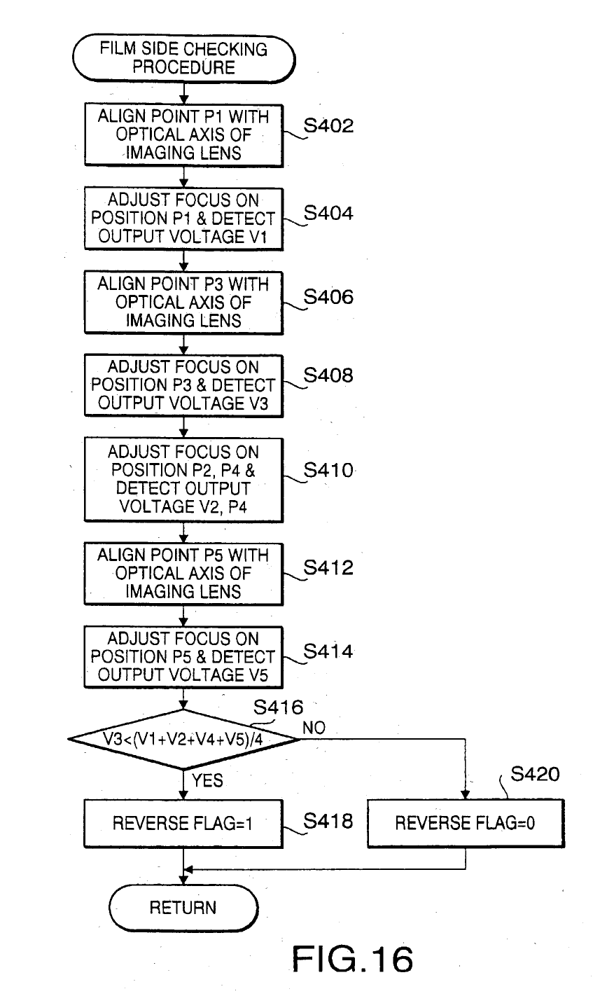

FIG. 16 shows a flowchart of the sub-routine FILM SIDE CHECKING PROCEDURE according to the second embodiment of the invention.

In step S402, the system controller 104 drives the pre-scanning motor 108 to move the film holder 201 and thereby align the front reference point P1 on the film strip with the optical axis of the imaging lens 402 (S402). Then, the system controller 140 adjusts the focus of the imaging lens 402 on the front reference point P1 by controlling the position of the imaging lens 402, and then detects the output voltage V1 of the linear position sensor 412 (S404).

Next, the film holder 201 is moved to align the center reference point P3 with the optical axis of the imaging lens 402 (S406). Then, the focus of the imaging lens 402 is adjusted on the center reference point P3, and the output voltages V3 of the liner position sensor 412 are detected (S408). The focus of the imaging lens 402 is also adjusted on the right and left reference points P2 and P4, and each time, the output voltage (V2, V4) of linear position sensor 412 is detected (S410).

Next, the film holder 201 is further moved to align the rear reference point PS with the optical axis of the imaging lens 402 (S412). Then, the focus of the imaging lens 402 is adjusted on the rear reference point P5 and then the output voltage V5 of the linear position sensor 412 is detected (S414).

Next, in step S416, the system controller 140 compares the value of voltage V3, which represents the distance to the center reference point P3, with the average value of the other four voltages (V1, V2, V4, V5), which represents the average distance to the other reference points,(P1, P2, P4, P5).

If the value of voltage V3 is smaller than the average value of the other four voltages (V1, V2, V4, V5) (S416:YES), it indicates that the distance to the center reference point P1 from the CCD line sensor is shorter than the average distance to the other reference points (P1, P2, P4, P5) and hence that the upper side of the film strip is the concave side or the emulsion side. In other words, it indicates that the film strip is reversely held in the film holder 201. Therefore, in this case, the system controller 140 sets the REVERSE FLAG (S418) so that the image reversing step S170 of FIG. 8 will be executed later.

On the contrary, if the value of voltage V3 is not smaller than the average value, which indicates that the under side of the film strip is the concave side or the emulsion side, the REVERESE FLAG is cleared (S420) so that the image reversing step S170 will not be executed.

After step S418 or S420 is executed, the control returns to the mains procedure shown in FIG. 7.

The present disclosure relates to the subject matter contained in Japanese Patent Application No. P2002-105982, filed on Apr. 9, 2002, which is expressly incorporated herein by reference in its entirety.

What is claimed is:

1. A film scanner that captures an image of a developed film by an imaging device, comprising:
a film holder arranged to hold said developed film with one side of said film facing toward said imaging device;
a film side discriminator that determines which side of said film held by said film holder is an emulsion side; and
an image processor that reverses an image captured from said film to produce an erect image when said film side discriminator determines that a side of said film not facing the imaging device is the emulsion side.

2. The film scanner according to claim 1, wherein said discriminator comprises:
a light source arranged to emit a light beam toward a side of said film held in said film holder; and
a photo detector arranged to receive said light beam reflected at said side of said film,
wherein said film side discriminator determines which side of said film is the emulsion side based on a characteristic of said light beam received by said photo detector.

3. The film scanner according to claim 2, wherein said film side discriminator determines the emulsion side of said film strip based on a width of said light beam received by said photo detector.

4. The film scanner according to claim 2, wherein said light source is an LED.

5. The film scanner according to claim 4, wherein said photo detector comprises a two dimensional array having a plurality of photosensitive elements, and
wherein said film side discriminator determines whether said light beam is reflected at the emulsion side of said film based on a number of photosensitive elements that receive said light beam.

6. The film scanner according to claim 5, wherein each of said photosensitive elements is a photo diode.

7. The film scanner according to claim 2, wherein said film side discriminator comprises:
a first light source arranged to emit a first light beam toward a first side of said film held by said film holder;
a first photo detector arranged to receive said first light beam reflected at said first side of said film;
a second light source arranged to emit a second light beam toward a second side of said film held by said film holder; and
a second photo detector arranged to receive said second light beam reflected at said second side of said film,
wherein said film side discriminator determines the emulsion side of said film based on outputs of said first and second photo detectors.

8. The film scanner according to claim 7, wherein each of said first and second light sources is an LED.

9. The film scanner according to claim 8, wherein each of said first and second photo detectors comprises a two dimensional array having a plurality of photosensitive elements, and
wherein said film side discriminator determines the emulsion side of said film by comparing a number of photosensitive elements of said first photo detector that receives said first light bean with a number of photosensitive elements of said second photo detector that receives said second light beam.

10. The film scanner according to claim 9, wherein each of said photosensitive elements is a photo diode.

11. The film scanner according to claim 1, wherein said film side discriminator determines the emulsion side of said film by detecting a concave side of said film.

12. The film scanner according to claim 11, wherein said film side discriminator determines distances from said imaging device to a plurality of points defined on the film and detects the concave side of said film based on said distances.

13. The film scanner according to claim 12, wherein one point of said plurality of points comprises a center reference point defined substantially at a center of one frame of said film and other points of said plurality of points are side reference points each defined in a vicinity of edges of said frame.

14. The film scanner according to claim 11, wherein said film side discriminator comprises:
an imaging lens located between said imaging device and said film holder, said imaging lens forming an image of said film on said imaging device; and
a lens driver that moves said lens along an optical axis thereof to adjust a focus of said imaging lens on said film,
wherein said film side discriminator determines positions of a plurality of points defined on said film in a direction parallel to said optical axis by adjusting said focus of said imaging lens on each point of said plurality of points, said film side discriminator detecting the concave side of said film based on said positions of said plurality of points.

15. The film scanner according to claim 14, wherein one point of said plurality of points comprises a center reference point defined substantially at a center of one frame of said film, and other points of said plurality of points comprise side reference points each defined in a vicinity of edges of said frame.
